(19) United States
(12) Patent Application Publication
(10) Pub. No.: US 2019/0225847 A1
(43) Pub. Date: Jul. 25, 2019

(54) DOUBLE-SIDED TAPE DEVICE

(71) Applicants: Tsinghua University, Beijing (CN); HON HAI PRECISION INDUSTRY CO., LTD., New Taipei (TW)

(72) Inventors: XIANG JIN, Beijing (CN); Zi-Peng Wu, Beijing (CN); Wen-Tao Miao, Beijing (CN); KAI-LI JIANG, Beijing (CN); SHOU-SHAN FAN, Beijing (CN)

(21) Appl. No.: 16/222,945

(22) Filed: Dec. 17, 2018

(30) Foreign Application Priority Data
Jan. 24, 2018 (CN) 201810070111.8

(51) Int. Cl. C09J 201/02; B26D 1/08

(52) U.S. Cl. CPC C09J 201/02; B26D 1/08; B82Y 40/00; C09J 2205/10; C09J 2201/128

(57) ABSTRACT

A double-sided tape device comprises a shell, a substrate, a super-aligned carbon nanotube array, and at least two drawing elements. The shell comprises a cover plate, a baseplate, and four side plates. The cover plate can be opened. The super-aligned carbon nanotube array is located in the shell and on the substrate, and the super-aligned carbon nanotube array is configured for drawing a double-sided tape therefrom. The at least two drawing elements is located on the substrate. The at least two drawing elements is configured for fixing the double-sided tape and drawing out the double-sided tape from the shell.

### CROSS-REFERENCE TO RELATED APPLICATIONS

This application claims all benefits accruing under 35 U.S.C. § 119 from China Patent Application No. 201810070111.8, filed on Jan. 24, 2018, in the China National Intellectual Property Administration, the contents of which are hereby incorporated by reference. The application is also related to copending applications entitled, “DOUBLE-SIDED TAPE DEVICE”, filed ______ (Atty. Docket No. US72471).

### FIELD

The present disclosure relates to a double-side tape device, and more particularly, relates to a carbon nanotube double-sided tape device.

### BACKGROUND

In both daily life and industrial production, double-sided tape is commonly used for bonding and fixing objects. However, an application temperature range of conventional double-sided tape is narrow; a viscosity of the conventional double-sided tape is significantly reduced or even lost at high temperatures or at low temperatures. For example, the viscosity of the conventional double-sided tape is significantly reduced or even lost when the temperature is larger than 70° C. or lower than 0° C.

Therefore, there is room for improvement within the art.

### BRIEF DESCRIPTION OF THE DRAWINGS

Implementations of the present technology will now be described, by way of example only, with reference to the attached figures, wherein:

FIG. 1 is a structure schematic diagram of one embodiment of a tape device.

FIG. 2 is a schematic view of drawing a super-aligned carbon nanotube film from a super-aligned carbon nanotube array of the tape device in FIG. 1.

FIG. 3 shows a structure schematic diagram of a substrate of the tape device in FIG. 1.

FIG. 4 shows a scanning electron microscope (SEM) image of the super-aligned carbon nanotube film in FIG. 2.

FIG. 5 is a structure schematic diagram of one embodiment of a tape device.

FIG. 6 is a structure schematic diagram of one embodiment of a tape device.

FIG. 7 is a structure schematic diagram of one embodiment of a tape device.

FIG. 8 shows a changing curve of adhesion strength of two objects bonded by a double side tape provided by the tape device in FIG. 1 changing a temperature.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean “at least one.”

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to illustrate details and features of the present disclosure better.

Several definitions that apply throughout this disclosure will now be presented.

The term “substantially” is defined to be essentially conforming to the particular dimension, shape, or other feature which is described, such that the component need not be exactly or strictly conforming to such a feature. The term “comprise,” when utilized, means “include, but not necessarily limited to”; it specifically indicates open-ended inclusion or membership in the so-described combination, group, series, and the like.

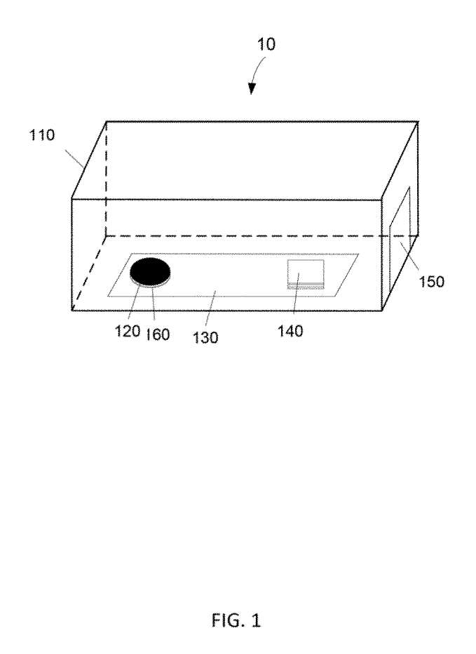

FIG. 1 shows one embodiment of the present application in relation to a tape device 10. The tape device 10 comprises a shell 110, a super-aligned carbon nanotube array 120, a first substrate 130, and at least two drawing elements 140. The shell 110 comprises an opening 150. The first substrate 130 is located in the shell 110. The super-aligned carbon nanotube array 120 is located in the shell 110 and on the first substrate 130. A double-sided tape can be continuously drawn from the super-aligned carbon nanotube array 120. The at least two drawing elements 140 are located on the first substrate 130 and spaced from the super-aligned carbon nanotube array 120. The at least two drawing elements 140 are used to fix the double-sided tape drawn from the super-aligned carbon nanotube array 120 and draw out the double-sided tape from the shell 110 through the opening 150. In one embodiment, the double-sided tape is drawn out from the shell 110 by the drawing element in direct contact with the double-sided tape.

The material and size of the shell 110 are not limited. In one embodiment, the shell 110 is made of a transparent material. A shape of the shell 110 is not limited, for example, the shape of the shell 110 can be a rectangular parallelepiped, a cube, or a cylinder. In one embodiment, the shell 110 is an integrated structure. In one embodiment, the shell 110 is assembled from multiple panels.

The super-aligned carbon nanotube array 120 is located on a second substrate 160. The super-aligned carbon nanotube array 120 comprises a plurality of carbon nanotubes parallel to each other and perpendicular to the second substrate 160. The plurality of carbon nanotubes of the super-aligned carbon nanotube array 120 is pure carbon nanotubes. The pure carbon nanotubes mean that the carbon nanotubes are not modified by physical or chemical methods, there are few or no impurities adhered on surfaces of the carbon nanotubes, and a purity of the carbon nanotubes is larger than or equal to 99.9%. The plurality of carbon nanotubes of the super-aligned carbon nanotube array 120 are in close contact with each other by van der Waals force.

The second substrate 160 can be selected from the group consisting of a P-type silicon substrate, an N-type silicon substrate, and a silicon substrate formed with an oxide layer. The second substrate 160 is fixed on the first substrate 130. In one embodiment, the second substrate 160 is adhered to the first substrate 130 by an adhesive. In one embodiment, the second substrate 160 is fixed on the first substrate 130 by a fastener. In one embodiment, the second substrate 160 is the P-type silicon substrate, and the second substrate 160 is adhered to the first substrate 130 by the adhesive.

A method for making the super-aligned carbon nanotube array 120 can be a chemical vapor deposition (CVD) method, an arc discharge preparation method, or an aerosol preparation method. In one embodiment, the super-aligned carbon nanotube array 120 is obtained by the chemical vapor deposition (CVD) method. The chemical vapor deposition (CVD) method comprises the block(s) of (a) providing the second substrate 160. Then (b) forming a catalyst layer on a surface of the second substrate 160, in which a material of the catalyst layer can be selected from the group consisting of iron (Fe), cobalt (Co), nickel (Ni) and alloy of any combination thereof. Step (c) is annealing the second substrate 160 with the catalyst layer in air at 700° C. to 900° C. for about 30 minutes to 90 minutes and (d) disposing the second substrate 160 in a reaction chamber. The reaction chamber is heated in protective gas to 500° C.˜−740° C., and a carbon source gas is introduced into the reaction chamber for about 5 minutes to about 30 minutes. The super-aligned carbon nanotube array 120 is grown from the second substrate. A height of the carbon nanotube of the super-aligned carbon nanotube array 120 is ranged from about 200 micrometers to about 400 micrometers. The carbon source gas can be chemically active hydrocarbons, such as acetylene. The protective gas can be nitrogen, ammonia, or an inert gas.

A material of the first substrate 130 is not limited. For example, the material of the first substrate 130 can be quartz, aluminum, plexiglass, or stainless steel. The first substrate 130 can be taken out from the shell 110.

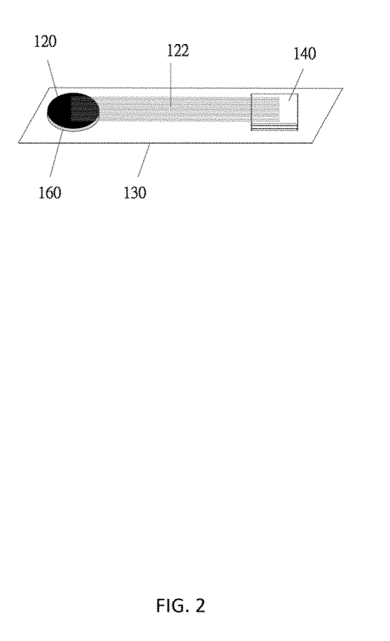

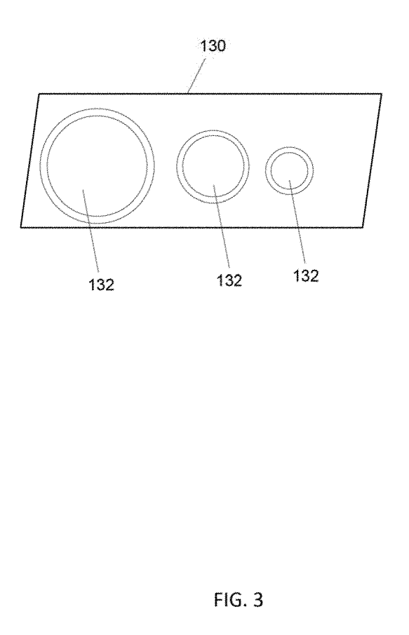

The uppermost one of the at least two drawing elements is defined as a first drawing element, the drawing element located below and in direct contact with the first drawing element is defined as a second drawing element, other drawing elements are defining in the same way. FIG. 2 shows that using the tape device 10 includes actions of, first taking out the first substrate 130 from the shell 110, drawing a super-aligned carbon nanotube film 122 from the super-aligned carbon nanotube array 120, and securing one end of the super-aligned carbon nanotube film 122 to the first drawing element. The super-aligned carbon nanotube film 122 is the double-sided tape. After the super-aligned carbon nanotube array 120 is used up, the first substrate 130 can be taken out from the shell 110 to place another super-aligned carbon nanotube array 120. In one embodiment, the first substrate 130 is fixed on the bottom of the shell 110 by a fastener, and the first substrate 130 can be taken out from the shell 110 after opening the fastener. FIG. 3 shows the first substrate 130 in one embodiment further comprising a plurality of different sized card slots 132, therefore, a plurality of super-aligned carbon nanotube arrays 120 of different sizes can be fixed on the first substrate 130.

The size and material of the at least two drawing elements 140 are not limited. The at least two drawing elements 140 have high requirements for cleanliness, and the at least two drawing elements can not introduce impurities during a process of drawing the double-sided tape. In one embodiment, each drawing element of the at least two drawing elements is a sheet structure, at least two sheet structures are stacked with each other, and the lowermost sheet structure is fixed to the first substrate 130 by an adhesive. In one embodiment, each sheet structure of the at least two sheet structures comprises an upper surface and a lower surface opposite to the upper surface; the upper surface comprises an adhesive layer, and the sheet structure is bonded to one end of the double-sided tape through the adhesive layer. Adjacent sheet structures are in contact with each other through the adhesive layer, and adjacent sheet structures can be separated from each other without being damaged. In one embodiment, the at least two drawing elements 140 are note papers, and each note paper comprises an adhesive layer.

In one embodiment, the tape device 10 further comprises a side-door (not shown), the side-door is located at the opening 150. The side-door is used for blocking the opening 150 when the tape device 10 is not in use, and thus a closed interior space inside the shell can be formed to prevent impurities, such as dust, from entering the shell 110 and polluting the super-aligned carbon nanotube array 120. The side-door can be opened to expose the opening 150 when the tape device 10 is in use, and the at least two drawing elements 140 can be drawn out from the shell 110 to draw out the double-side tape.

When the tape device 10 is used for the first time, the first use steps of the tape device 10 comprises:

block (B1), drawing a super-aligned carbon nanotube film from the super-aligned carbon nanotube array 120 by a stretching tool, and fixing one end of the super-aligned carbon nanotube film to the first drawing element, and the super-aligned carbon nanotube film is the double-side tape;

block (B2), drawing out the first drawing element from the opening 150 along a horizontal direction and laying the double-side tape on and in direct contact with a first surface to be bonded; and

block (B3), cutting the double-side tape at the opening 150 and separating the double-side tape from the first drawing element.

In block (B1), a method of drawing the super-aligned carbon nanotube film from the super-aligned carbon nanotube array 120 by the stretching tool comprises: block (B11), selecting a plurality of carbon nanotube segments with a certain width from the super-aligned carbon nanotube array 120; and block (B12), stretching the plurality of carbon nanotube segments substantially perpendicular to a growth direction of the super-aligned carbon nanotube array 120 at a certain speed, to obtain the super-aligned carbon nanotube film. In one embodiment, the stretching tool is a tape.

After cutting the double-side tape at the opening 150, the double-side end of the tape attached to the super-aligned carbon nanotube array 120 is bonded to the second drawing element. Therefore, the subsequent use steps of the tape device 10 comprises: drawing out the second drawing element from the opening 150 along the horizontal direction and laying the double-side tape on a second surface to be bonded; and cutting the double-side tape at the opening 150 and separating the double-side tape from the second drawing element. And the like, the double-side tape can be drawn out by drawing the drawing element when using the tape device 10 each time. In one embodiment, after the super-aligned carbon nanotube array 120 is used up, another super-aligned carbon nanotube array 120 is placed on the first substrate 130; the double-side tape is also drawn by the first use steps and the subsequent use steps.

In block (B3), the double-side tape located on and in direct contact with the first surface to be bonded is defined as a first tape. In one embodiment, after block (B3), the first use steps of the tape device 10 further comprises: block (B4), drawing out the second drawing element from the opening 150 along the horizontal direction and laying a second double-side tape on and in direct contact with the first double-side tape; and block (B5), cutting the second double-side tape at the opening 150 and separating the double-side tape from the second drawing element. In one embodiment, repeating block (B4) and block (B5) multiple times, a double-side tape comprising a plurality of super-aligned carbon nanotube films stacked with and parallel to each other can be obtained, and the carbon nanotubes in the plurality of carbon nanotube films extend in a same direction.

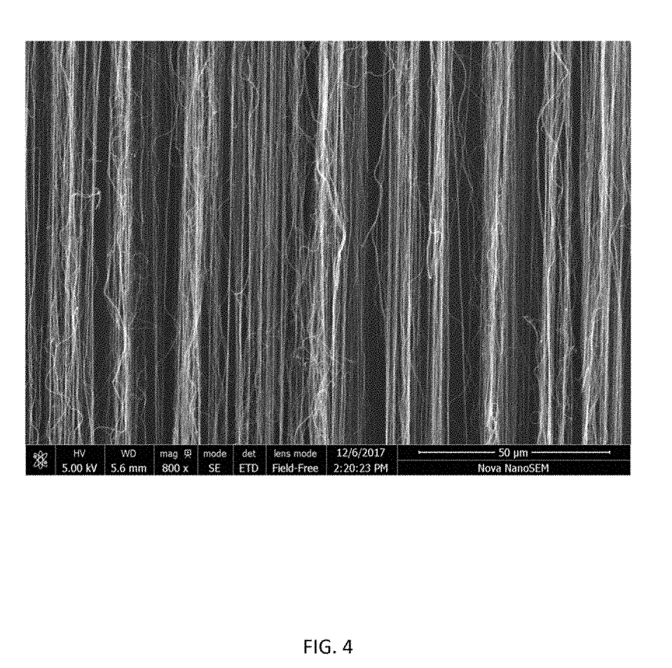

FIG. 4 shows the super-aligned carbon nanotube film 122 comprising a plurality of carbon nanotubes. The plurality of carbon nanotubes extends substantially along the same direction. The extending direction of the plurality of carbon nanotubes is substantially parallel to a surface of the super-aligned carbon nanotube film 122. The plurality of carbon nanotubes extends substantially along the same direction implies that a majority of the carbon nanotubes in the super-aligned carbon nanotube film 122 extends along the same direction. A minority of carbon nanotubes may be randomly aligned. However, the number of randomly aligned carbon nanotubes is very small and does not affect the overall oriented alignment of the majority of carbon nanotubes in the super-aligned carbon nanotube film 122. The randomly aligned carbon nanotubes can be effectively ignored. The plurality of carbon nanotubes of the super-aligned carbon nanotube film 122 are joined end-to-end by van der Waals force. Adjacent carbon nanotubes along the extending direction are joined end-to-end by van der Waals force.

In one embodiment, the plurality of carbon nanotubes is pure carbon nanotubes. Pure carbon nanotubes are carbon nanotubes that are not modified by physical or chemical methods, include few or no impurities adhered on surfaces of the carbon nanotubes, and have a purity of the carbon nanotubes that is larger than or equal to 99.9%. The carbon nanotube structure 10 contains no organic solvents.

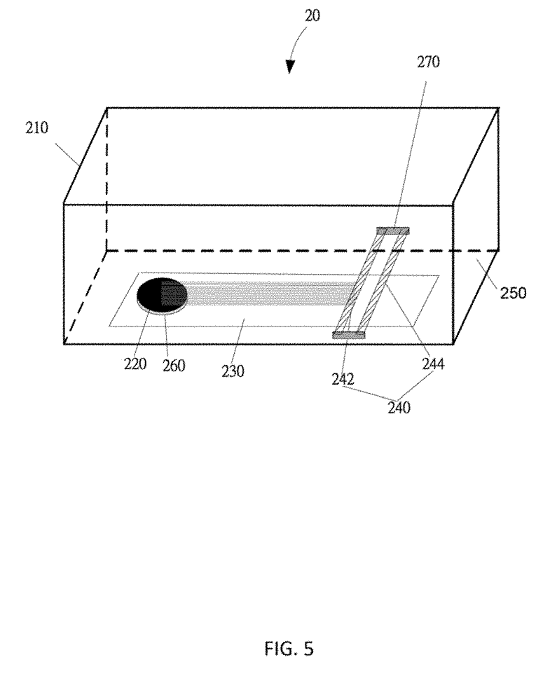

FIG. 5 shows one embodiment of the present application in relation to a tape device 20. The tape device 20 comprises a shell 210, a super-aligned carbon nanotube array 220, a first substrate 230, and at least two drawing elements 240. The shell 210 comprises an opening 250. The first substrate 230 is located in the shell 210. The super-aligned carbon nanotube array 220 is located in the shell 210 and on the first substrate 230.

The tape device 20 is substantially the same as the tape device 10, except that the tape device 20 further comprises a first support 270 and a second support 280, and the at least two drawing elements 240 are at least two drawbars. The first support 270 is located on a first side wall of the shell 210, the second support 280 is located on a second side wall of the shell 210 opposite to the first side wall; and the first side wall and the second side wall are parallel to a drawing direction of the double-side tape. The at least two drawbars are spaced apart from each other. Each of the at least two drawbars comprises a first end, a middle portion, and a second end. The first end is located on the first support 270, the second end is located on the second support 280, and the middle portion is suspended in air.

The material, size and quantity of the at least two drawbars can be selected according to actual needs. The at least two drawbars can be recycled. In one embodiment, surfaces of the at least two drawbars are smooth surfaces, smooth surfaces are more conducive to winding the super-aligned carbon nanotube film on the at least two drawbars. In one embodiment, the tape device 20 comprises a first drawbar 242 and a second drawbar 244.

The material and size of the first support 270 and the second support 280 can be selected according to actual needs. In one embodiment, a plurality of baffles are arranged on a surface of each of the first support 270 and the second support 280, and the plurality of baffles are spaced from each other; the plurality of baffles are used for spacing the at least two drawing elements 240. In one embodiment, a plurality of first supports 270 is spaced and located on the first side wall of the shell 210, a plurality of second supports 280 is spaced and located on the second side wall of the shell 210, the plurality of first supports 270 and the plurality of second supports 280 are in one-to-one correspondence; the first end of each drawbar is located on the first support 270, and the second end of each drawbar is located on the second support 280 corresponding to the first support 270. In one embodiment, each of the first support 270 and the second support 280 comprises a plurality of fasteners, the plurality of fasteners is used to fix the first end of each of the at least two drawbars on the first support 270 and fix the second end of each of the at least two drawbars on the second support 280; during using the tape device 20, the plurality of fasteners can be opened to draw out the at least two drawbars from the shell 210.

The first support 270 and the second support 280 are selectable. In one embodiment, the tape device 20 does not comprise the first support 270 and the second support 280; and the first side wall of the shell 210 comprises a first track, and the second side wall of the shell 210 comprises a second track. The first end of each drawbar is located in the first track, the second end of each drawbar is located in the second track, and the middle portion is suspended in air. Drawing out at least two drawbars from the shell along the first track and the second track during using the tape device 20.

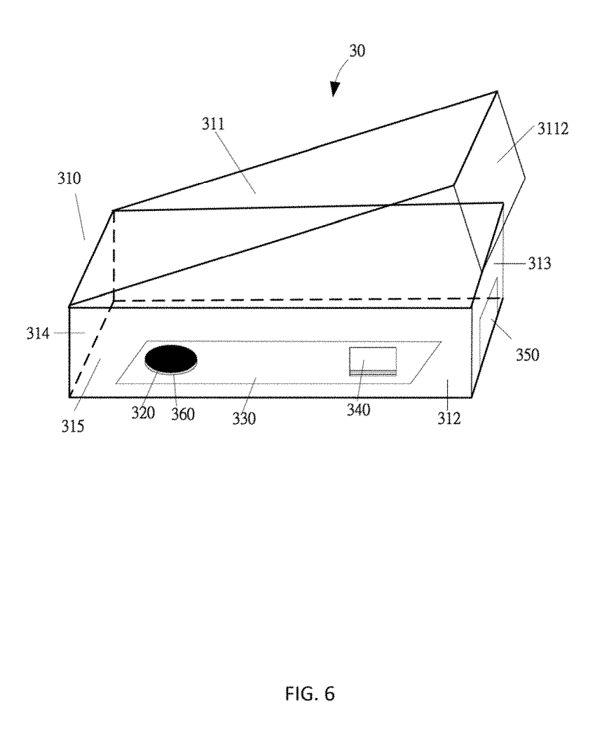

FIG. 6 shows one embodiment of the present application in relation to a tape device 30. The tape device 30 comprises a shell 310, a super-aligned carbon nanotube array 320, a first substrate 330, and at least two drawing elements 340. The first substrate 330 is located in the shell 310. The super-aligned carbon nanotube array 320 is located in the shell 310 and on a second substrate 360.

The tape device 30 is substantially the same as the tape device 10, except that the shell 310 is different from the shell 110. The shell 310 comprises a cover plate 311, a baseplate 312 opposite to the cover plate 311, and four side plates 313. The cover plate 311 can be opened. One of the four side plates 313 comprises an opening 350. The side plate comprising the opening 350 is defined as a first side plate, and the side plate 313 opposite to the first side plate is defined as a second plate. The cover plate 311 comprises a first end and a second end. The first end is connected to the first side plate, and the second end is adjacent to the second side plate.

In one embodiment, the cover plate 311 comprises an extending portion 3112. The extending portion 3112 is located at the second end of the cover plate 311. An angle is formed between the extending portion 3112 and the cover plate 311, and the angle is larger than or equal to 0 degrees and less than or equal to 90 degrees. In one embodiment, the angle formed between the extending portion 3112 and the cover plate 311 is about 90 degrees. The extending portion 3112 is used for covering the opening 350 when the cover plate 311 is covered on the shell 310. In one embodiment, a cutting element is located at an end of the extending portion 3112; the cutting element can cut the super-aligned carbon nanotube film at the opening 350 when the cover plate 311 is covered on the shell 310. A material of the cutting element is not limited as long as the super-aligned carbon nanotube film can be cut. In one embodiment, the cutting element is a metal blade.

When the tape device 30 is used for the first time, the first use steps of the tape device 30 comprises:

block (B′1), opening the cover plate 311, drawing a super-aligned carbon nanotube film from the super-aligned carbon nanotube array 320 by a stretching tool, and fixing one end of the super-aligned carbon nanotube film to the first drawing element of the at least two drawing elements, the super-aligned carbon nanotube film is a double-side tape;

block (B′2), drawing out the first drawing element from the opening 350 along a horizontal direction and laying the double-side tape on and in direct contact with a first surface to be bonded; and

block (B′3), covering the cover plate 311 on the shell 310, cutting the double-side tape at the opening 350 by the cutting element, and separating the double-side tape from the first drawing element.

In block (B′1), a method of drawing the super-aligned carbon nanotube film from the super-aligned carbon nanotube array 320 by the stretching tool is the same with the method of drawing the super-aligned carbon nanotube film from the super-aligned carbon nanotube array 120.

After cutting the tape at the opening 350, the end of the double-side tape attached to the super-aligned carbon nanotube array 320 is bonded to the second drawing element. Therefore, the subsequent use steps of the tape device 30 comprises: drawing out the second drawing element from the opening 350 along the horizontal direction and laying the tape on a second surface to be bonded; and covering the cover plate 311 on the shell 310, cutting the double-side tape at the opening 350 by the cutting element, and separating the double-side tape from the second drawing element. And the like, the double-side tape can be drawn out by drawing the drawing element when using the tape device 30 each time. In one embodiment, after the super-aligned carbon nanotube array 320 is used up, another super-aligned carbon nanotube array 320 is placed on the substrate 330; the double-side tape is also drawn by the first use steps and the subsequent use steps of the tape device 30.

In block (B′3), the double-side tape located on and in direct contact with the first surface to be bonded is defined as a third double-side tape. In one embodiment, after block (B′3), the first use steps of the tape device 30 further comprises: block (B′4), drawing out the second drawing element from the opening 350 along the horizontal direction and laying a fourth double-side tape on and in direct contact with the third double-side tape; and block (B′5), cutting the fourth double-side tape at the opening 350 and separating the fourth double-side tape from the second drawing element. In one embodiment, repeating block (B′4) and block (B′5) multiple times, a tape comprising a plurality of super-aligned carbon nanotube films stacked with and parallel to each other can be obtained, and the carbon nanotubes in the plurality of super-aligned carbon nanotube films extend in a same direction.

The first substrate 330 is selectable. In one embodiment, the tape device 30 does not comprise the first substrate 330, and the second substrate 360 is directly fixed to the bottom of the shell 310.

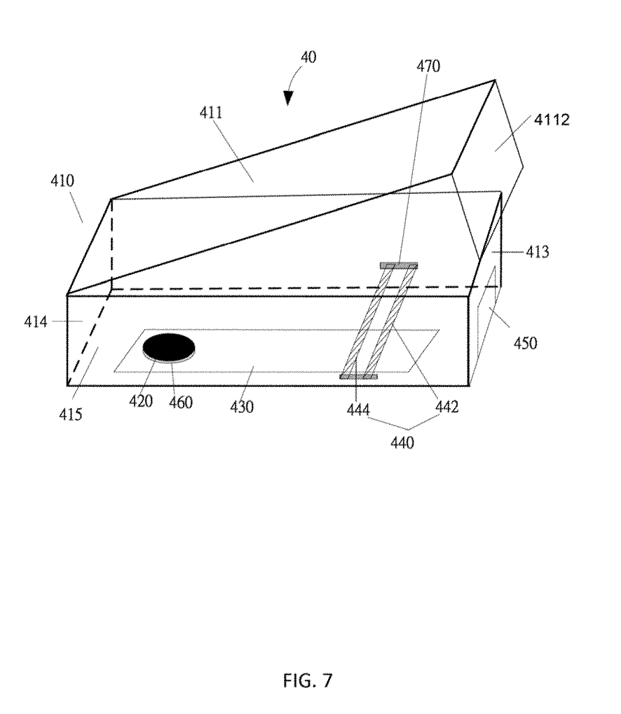

FIG. 7 shows one embodiment of the present application in relation to a tape device 40. The tape device 40 comprises a shell 410, a super-aligned carbon nanotube array 420, a first substrate 430, and at least two drawing elements 440. The first substrate 430 is located in the shell 410. The super-aligned carbon nanotube array 420 is located in the shell 410 and on a second substrate 460. The shell 410 comprises a cover plate 411, a baseplate 412 opposite to the cover plate 411, and four side plates 413. The cover plate 411 can be opened. One of the four side plates 413 comprises an opening 450. The side plate comprising the opening 450 is defined as a first side plate, and the side plate opposite to the first side plate is defined as a second plate. The cover plate 411 comprises a first end and a second end. The first end is connected to the first side plate, and the second end is adjacent to the second side plate.

The cover plate 411 comprises an extending portion 4112. The extending portion 4112 is located at the second end of the cover plate 411. An angle is formed between the extending portion 4112 and the cover plate 411, and the angle is larger than or equal to 0 degrees and less than or equal to 90 degrees. In one embodiment, the angle formed between the extending portion 4112 and the cover plate 411 is about 90 degrees. In one embodiment, a cutting element is located at an end of the extending portion 4112; the cutting element can cut the super-aligned carbon nanotube film at the opening 450 when the cover plate 411 is covered on the shell 410.

The tape device 40 is substantially the same as the tape device 30, except that the tape device 40 further comprises a first support 470 and a second support 480, and the at least two drawing elements 440 are at least two drawbars. The at least two drawbars are spaced apart from each other. Each of the at least two drawbars comprises a first end, a middle portion, and a second end. The first end is located on the first support 470, the second end is located on the second support 480, and the middle portion is suspended in air.

The material, size and quantity of the at least two drawbars can be selected according to actual needs. The at least two drawbars can be recycled. In one embodiment, surfaces of the at least two drawbars are smooth surfaces, smooth surfaces are more conducive to winding the super-aligned carbon nanotube film on the at least two drawbars. In one embodiment, the tape device 40 comprises a first drawbar 442 and a second drawbar 444.

The material and size of the first support 470 and the second support 480 can be selected according to actual needs. In one embodiment, a plurality of baffles are arranged on a surface of each of the first support 470 and the second support 480, and the plurality of baffles are spaced from each other; the plurality of baffles are used for spacing the at least two drawing elements 440. In one embodiment, a plurality of first supports 470 is spaced and located on the first side wall of the shell 410, a plurality of second supports 480 is spaced and located on the second side wall of the shell 410, the plurality of first supports 470 and the plurality of second supports 480 are in one-to-one correspondence; the first end of each drawbar is located on the first support 470, and the second end of each drawbar is located on the second support 480 corresponding to the first support 470. In one embodiment, each of the first support 470 and the second support 480 comprises a plurality of fasteners, the plurality of fasteners is used to fix the first end of each of the at least two drawbars on the first support 470 and fix the second end of each of the at least two drawbars on the second support 480; during using the tape device 40, the plurality of fasteners can be opened to draw out the at least two drawbars from the shell 410.

The first support 470 and the second support 480 can be selectable. In one embodiment, the tape device 40 does not include the first support 470 and the second support 480, the first side wall of the shell 410 comprises a first track, and the second side wall of the shell 410 comprises a second track. The first end of each drawbar is located in the first track, the second end of each drawbar is located in the second track, and the middle portion is suspended in air. The at least two drawbars can be drawn out from the shell along the first track and the second track during using the tape device 40.

The double-side tape obtained using the tape device 10, 20, 30 or 40 of the present disclosure has many advantages.

First, the absence or almost complete absence of impurities adhered on surfaces of the plurality of carbon nanotubes of the double-side tape, such as amorphous carbon or residual catalyst metal particles, provides high thermal stability for the double-side tape, and the double-side tape is not easily oxidized even at high temperatures.

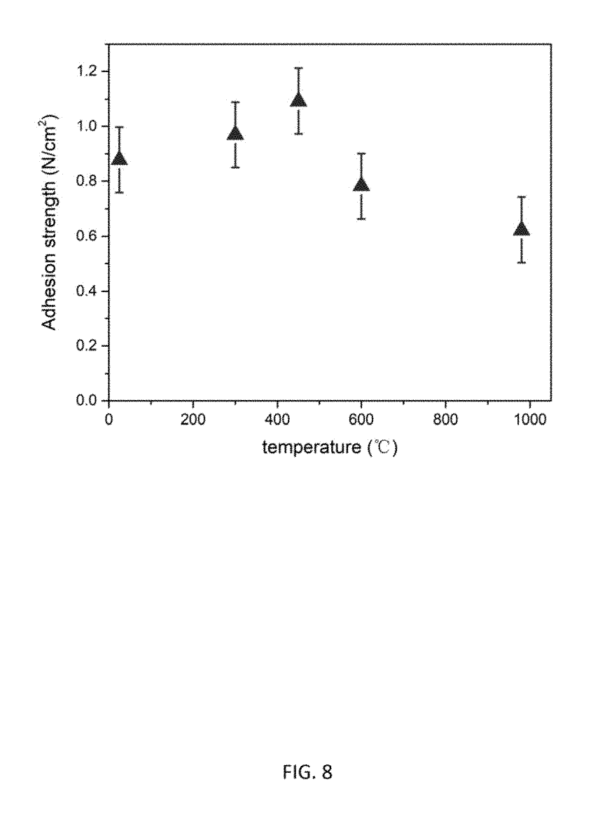

Second, the double-side tape comprising the super-aligned carbon nanotube film is bonded to the objects only through van der Waals force and temperature has minor effects on Van der Waals force. Therefore, the double-side tape comprising the super-aligned carbon nanotube film still has excellent stickiness at high and low temperatures, for example, the double-side tape still has excellent stickiness at about −196° C. and at about 1000° C. An application temperature range of the double-side tape is wide. FIG. 8 shows that change in temperature minor changes the adhesion strength between two objects bonded by the double-side tape. In one embodiment, the application temperature range of the double-side tape is from about −196° C. to about 1000° C. In one embodiment, the application temperature range of the double-side tape is from about −196° C. to about −100° C. In one embodiment, the application temperature range of the double-side tape is from about 500° C. to about 1000° C. In another embodiment, the application temperature range of the double-side tape is from about 800° C. to about 1000° C.

Third, the double-side tape is bonded to the object only by van der Waals force. When the objects need to be separated from each other, the objects can be separated from each other only by a force without heating or dissolving with solvent, and the double-side tape can be removed from the bonded surfaces without causing damage to the bonded surfaces after the objects are separated from each other. When the double-side tape is used, a bonding position can be adjusted.

Fourth, the super-aligned carbon nanotube array is located in the shell; and the double-side tape is drawn from the super-aligned carbon nanotube array and directly laid on the surface to be bonded. Therefore, the pollution of the double-side tape during storage and use can be avoided, and thus the viscosity reduction of the double-side tape can also be avoided.

The above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

Depending on the embodiment, certain of the blocks of a method described may be removed, others may be added, and the sequence of blocks may be altered. The description and the claims drawn to a method may include some indication in reference to certain blocks. However, the indication used is only to be viewed for identification purposes and not as a suggestion as to an order for the blocks.

What is claimed is:

1. A double-sided tape device comprising:
a shell comprising a cover plate, a baseplate opposite to the cover plate, a first side plate comprising an opening, a second side plate opposite to the first side plate, a third side plate and a fourth side plate opposite to the third side plate, wherein the cover plate is capable of being opened;
a first substrate located in the shell;
a super-aligned carbon nanotube array located in the shell and on the first substrate, the super-aligned carbon nanotube array being configured to draw a double-sided tape therefrom, and a drawing direction of the double-sided tape is parallel to the third side wall and the fourth side wall; and
at least two drawing elements located on the first substrate and spaced from the super-aligned carbon nanotube array, the at least two drawing elements being configured to fix the double-sided tape and draw out the double-sided tape from the shell.

2. The double-sided tape device of claim 1, wherein the super-aligned carbon nanotube array is located and grown on a second substrate, the second substrate is fixed on the first substrate, and the super-aligned carbon nanotube array comprises a plurality of carbon nanotubes parallel to each other and perpendicular to the second substrate.

3. The double-sided tape device of claim 1, wherein the cover plate comprises a first end and a second end, the first end is connected to the first side plate, and the second end is adjacent to the second side plate.

4. The double-sided tape device of claim 3, wherein the cover plate further comprises an extending portion, and the extending portion is located at the second end of the cover plate.

5. The double-sided tape device of claim 4, wherein an angle between the extending portion and the cover plate is larger than or equal to 0 degree and less than or equal to 90 degree.

6. The double-sided tape device of claim 4, wherein the extending portion is configured to cover the opening.

7. The double-sided tape device of claim 4, further comprising a cutting element located at an end of the extending portion, wherein the cutting element is configured to cut the double-sided tape at the opening.

8. The double-sided tape device of claim 1, wherein the first substrate comprises a plurality of card slots with different sizes, and the plurality of card slots with different sizes is configured to fix a plurality of super-aligned carbon nanotube arrays.

9. The double-sided tape device of claim 1, wherein the at least two drawing elements are at least two sheet structures stacked with each other.

10. The double-sided tape device of claim 9, wherein each sheet structure of the at least two sheet structures comprises a surface with an adhesive layer, and the double-side tape is bonded to each sheet structure s through the adhesive layer.

11. The double-sided tape device of claim 10, wherein adjacent sheet structures of the at least two sheet structures are bonded together through the adhesive layer, and adjacent sheet structures is capable of being separated from each other without being damaged.

12. The double-sided tape device of claim 1, wherein the at least two drawing elements are at least two drawbars, each of the at least two drawbars comprises a first end, a second end and a middle portion located between the first end and the second end.

13. The double-sided tape device of claim 12, wherein the double-sided tape device comprises a first support located on the third side wall and a second support located on the fourth side wall; and the first end is located on the first support, the second end is located on the second support, and the middle portion is suspended in air.

14. The double-sided tape device of claim 13, wherein a plurality of baffles are arranged on a surface of each of the first support and the second support, and the plurality of baffles is spaced from each other and configured to space the at least two drawing drawbars.

15. The double-sided tape device of claim 12, wherein the third side wall comprises a first track, and the fourth side wall comprises a second track; and the first end is located in the first track, the second end is located in the second track, and the middle portion is suspended in air.

16. The double-sided tape device of claim 12, wherein the at least two drawbars are recycled.

17. The double-sided tape device of claim 1, wherein an application temperature of the double-sided tape is ranged from about −196° C. to about 1000° C.

18. The double-sided tape of claim 17, wherein the application temperature of the double-sided tape is ranged from about −196° C. to about −100° C.

19. The double-sided tape of claim 17, wherein the application temperature of the double-sided tape is ranged from about 500° C. to about 1000° C.

20. A double-sided tape device comprising:
a shell comprising a cover plate, a baseplate opposite to the cover plate, a first side plate, a second side plate opposite to the first side plate, a third side plate and a fourth side plate opposite to the third side plate, wherein the cover plate is capable of being opened;
a substrate located in the shell;
a super-aligned carbon nanotube array located in the shell and on the substrate, the super-aligned carbon nanotube array being configured to draw a double-sided tape therefrom, wherein the double-sided tape comprises a super-aligned carbon nanotube film, and the super-aligned carbon nanotube film comprises a plurality of carbon nanotubes, the plurality of carbon nanotubes extend substantially along an extending direction; and
at least two drawing elements located on the first substrate and spaced from the super-aligned carbon nanotube array, the at least two drawing elements being configured to fix the double-sided tape and draw out the double-sided tape from the shell.
